(19) United States
(12) Patent Application Publication
(10) Pub. No.: US 2005/0254811 A1
(43) Pub. Date: Nov. 17, 2005

(54) Digital camera and portable device

(75) Inventor: Kazuhito Taneoka, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/121,035

(22) Filed: May 4, 2005

(30) Foreign Application Priority Data
May 12, 2004 (JP) 2004-142898

(51) Int. Cl. G03B 7/00

(52) U.S. Cl. 396/287; 396/299

(57) ABSTRACT

A digital camera includes a display device rotatable relative to a camera body of the digital camera, the display device including a display panel; an orientation detecting device which detects a rotation of the display device to determine an orientation of the display panel of the display device; a plurality of manual operating switches for controlling an image display indicated on the display panel of the display device; and a controller for controlling functions assigned to the manual operating switches. The controller changes assignments of the functions to the manual operating switches in accordance with the orientation of the display panel upon detecting a change in the orientation of the display panel from a result of detection of the orientation detecting device.

### BACKGROUND OF THE INVENTION

1. Field of the Invention

The present invention relates to a digital camera having a manual operation member and a display device, the position of which can be changed, and further relates to any other type of portable device having a manual operation member and such a display device.

2. Description of the Related Art

Some conventional digital still/video cameras (hereinafter referred to simply as digital cameras) are provided with a display device (monitor) which indicates captured images and setting menus for various functions of the camera and which can be oriented forwards or rearwards with respect to the digital camera to correspond to photographing conditions. This type of digital camera is disclosed in Japanese laid-open patent publication H06-98210.

Although the user faces the display device to visually check the image display indicated on a display panel of the display device before operating the camera, different functions assigned to various operating switches are invariable independently of the position of the user relative to the camera, and accordingly, it is sometimes the case that the user operates such operating switches mistakenly, e.g., the up operating switch can be mistakenly operated instead of the down operating switch and vice versa, or the left operating switch can be mistakenly operated instead of the right operating switch and vice versa. An increase in the number of operating switches due to multifunctionality of recent digital cameras can be a potential cause of such an operation mistake.

A similar problem has arisen in portable or mobile devices other than digital cameras, e.g., recently manufactured mobile phones having a rotatable LCD unit.

### SUMMARY OF THE INVENTION

The present invention provides a digital camera which makes it possible for the user to operate the camera so as to perform the same operation at any time regardless of the position of the user relative to the digital camera when the user operates the digital camera, thus obtaining an improvement in operability of the digital camera.

The present invention provides a portable device such as a digital camera which is improved in operability of the portable device when the orientation of a display device of the portable device relative to a manual operation member of the portable device is changed.

According to an aspect of the present invention, a digital camera is provided, including a display device that is rotatably supported on a camera body of the digital camera, the display device_indicating a plurality of selectable functions of the camera on a display panel; an orientation detecting device which detects an angular position of the display device with respect to the camera body to determine an orientation of the display panel of the display device; a plurality of manual operating switches, each of the manual operating switches being adapted to select the selectable functions indicated on the display panel; and a controller for assigning functions to the manual operating switches. The controller changes assignments of the functions to the manual operating switches in accordance with the angular position of the display device detected by the orientation detecting device.

It is desirable for the manual operating switches to be positioned on a top surface of the camera body.

It is desirable for the display panel of the display device to be positioned to lie in a plane substantially orthogonal to an optical axis of a photographing optical system of the digital camera so that the display panel can be viewed at least from one of a front side and a rear side of the camera body by rotating the display device.

It is desirable for the display device to be rotatable on an axis which is orthogonal to the optical axis.

It is desirable for the digital camera to include a function informing device for informing the functions assigned to the manual operating switches.

It is desirable for the function informing device to include at least one light emitter capable of emitting different colors of light for lighting the manual operating switches. The controller controls operation of the light emitter so that the light emitter changes color of light emitted therefrom to change a color of each the manual operating switches in accordance with the result of detection of the orientation detecting device.

It is desirable for the function informing device to include a plurality of LEDs which are positioned inside the manual operating switches, respectively.

It is desirable for the digital camera to include a connector portion to which an external device having a display monitor is connectable; and a connector detector for detecting whether the external device is connected to the connector portion. The controller prohibits the assignments of the functions to the manual operating switches from being changed in the case where the connector detector detects that the external device is connected to the connector portion.

It is desirable for the display device to be pivoted to a rear end of the camera body.

It is desirable for the display device to be rotatable about a second axis which is orthogonal to the axis.

It is desirable for the manual operating switches to be a multi-direction control button which can be operated in biaxial directions orthogonal to each other.

In an embodiment, a digital camera is provided, including a display device that is rotatably supported on a camera body of the digital camera, the display device indicating a plurality of selectable functions of the camera on a display panel; a plurality of manual operating switches, each of the manual operating switches being adapted to select the selectable functions indicated on the display panel; and a controller which changes assignments of functions to the manual operating switches in accordance with variations in an angular position of the display device relative to the camera body.

In an embodiment, a portable device is provided, including a display device configured so that an orientation of a display panel of the display device relative to an operating portion is changeable; an orientation detecting device for detecting a change in the orientation of the display panel; a manual operation member, provided on the operating portion, for controlling an image display indicated on the display panel of the display device; and a controller for controlling functions of the manual operation member. The controller changes functions of the manual operation member in accordance with the orientation of the display panel upon detecting a change in the orientation of the display panel from a result of detection of the orientation detecting device.

The present disclosure relates to subject matter contained in Japanese Patent Application No.2004-142898 (filed on May 12, 2004) which is expressly incorporated herein by reference in its entirety.

### BRIEF DESCRIPTION OF THE DRAWINGS

The present invention will be described below in detail with reference to the accompanying drawings in which:

FIG. 1 is a front perspective view of an embodiment of a digital camera according to the present invention;

FIG. 2 is a front perspective view of the digital camera shown in FIG. 1, viewed from a different angle;

FIG. 3 is a rear elevational view of the digital camera shown in FIGS. 1 and 2;

FIG. 4 is a side elevational view of the digital camera shown in FIGS. 1 and 2, viewed from the grip side;

FIG. 5 is a side elevational view of the digital camera shown in FIGS. 1 and 2, showing a state in which an LCD monitor unit is in an upright position;

FIG. 6 is a block diagram of a control system of the digital camera shown in FIGS. 1 and 2;

FIG. 7 is a flow chart showing a process of setting functions of a five-way control button provided on a camera body of the digital camera shown in FIGS. 1 and 2;

FIG. 8 is a diagram showing assignment patterns of functions to the five-way control button;

FIG. 9 is a front view in perspective of the digital camera shown in FIGS. 1 and 2, showing that the LCD monitor unit is rotatable not only about a first axis of rotation but also about a second axis of rotation; and

FIG. 10 is a flow chart showing another process of setting functions of the five-way control button in the case where the LCD monitor unit is rotatable both about the first axis of rotation and about the second axis of rotation.

### DESCRIPTION OF THE PREFERRED EMBODIMENT

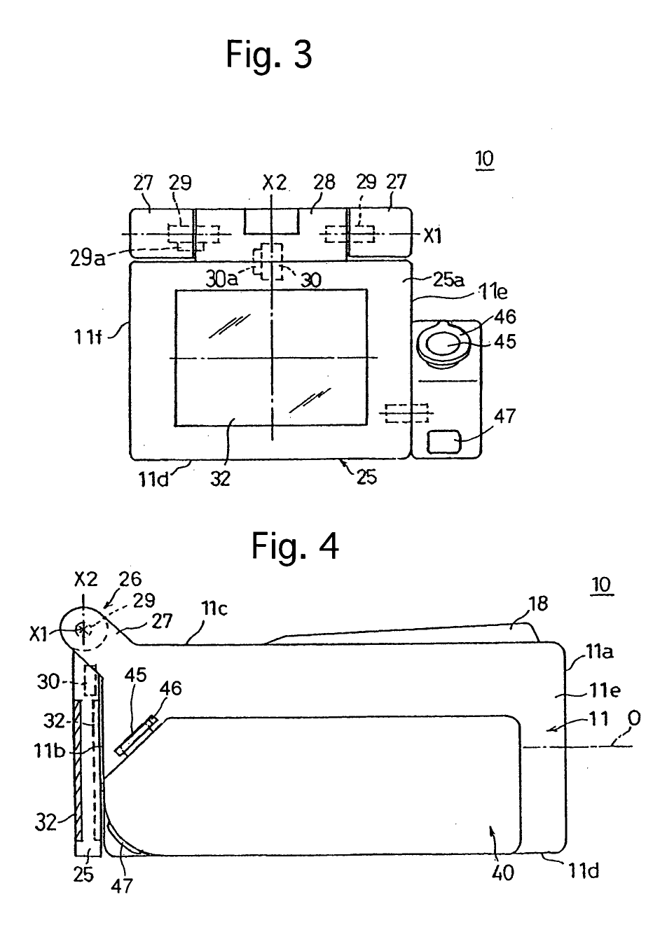

An embodiment of a digital camera 10 is provided with a camera body (outer casing) 11 including a photographing optical system (image-forming optical system). The camera body 11 is formed as a substantially rectangular parallelepiped which is elongated along an optical axis O of the photographing optical system. The outer surface of the camera body 11 is composed of six surfaces (flat portions): a front end surface 11a, a rear end surface 11b, a top surface 11c, a bottom surface 11d, a right side surface 11e and a left side surface 11f. The top surface 11c, the bottom surface 11d, the right side surface 11e and the left side surface 11f connect the front end surface 11a with the rear end surface 11b, and surround the optical axis O. In the present embodiment of the digital camera 10, the vertical direction and the horizontal direction of FIG. 3 correspond to the vertical direction and the horizontal direction of the digital camera 10, respectively. In addition, a direction parallel to the optical axis O is defined as a forward/rearward direction of the digital camera 10, the front end surface 11a is defined as the front side of the digital camera 10, and the rear end surface 11b is defined as the rear side of the digital camera 10.

The digital camera 10 is provided in the camera body 11 with a frontmost lens group LF of the photographing optical system which is exposed to the outside of the camera body 10 from the front end surface 11a. The frontmost lens group LF can be a lens group consisting of a single lens element or a plurality of lens elements. The photographing optical system of the digital camera 10, that is provided inside the camera body 11, is a zoom lens optical system having more than one lens group in addition to the frontmost lens group LF. Specifically, the photographing optical system is an internal-focusing/zooming optical system in which the focus or the focal length is altered by moving elements internally within the lens barrel (i.e., the external lens barrel is not extended or retracted). Accordingly, the frontmost lens group LF does not move forward from the position thereof shown in the drawings.

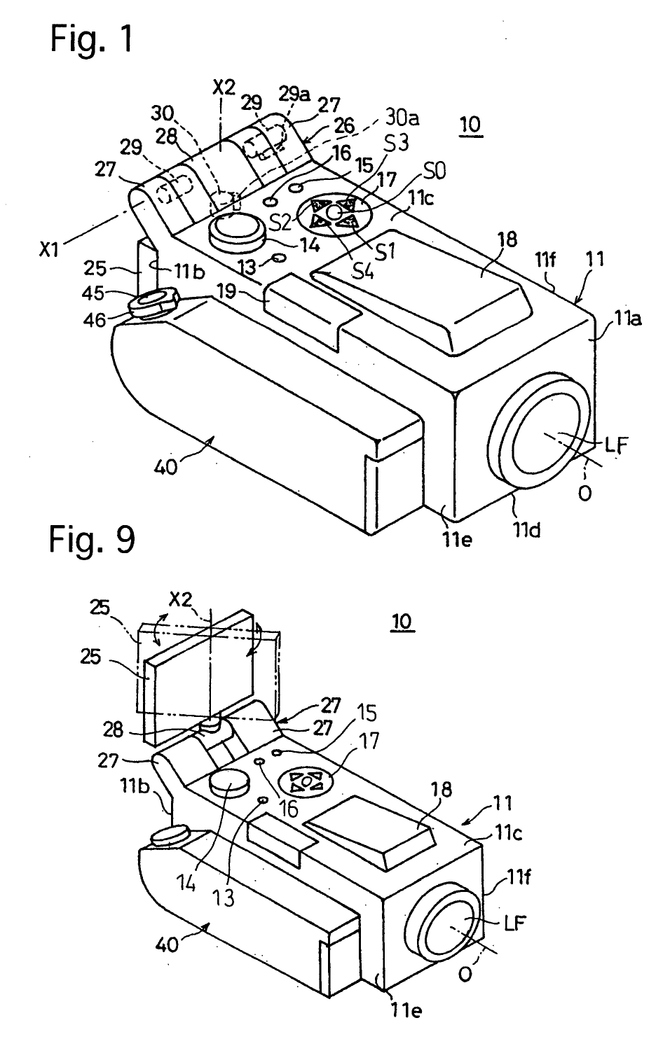

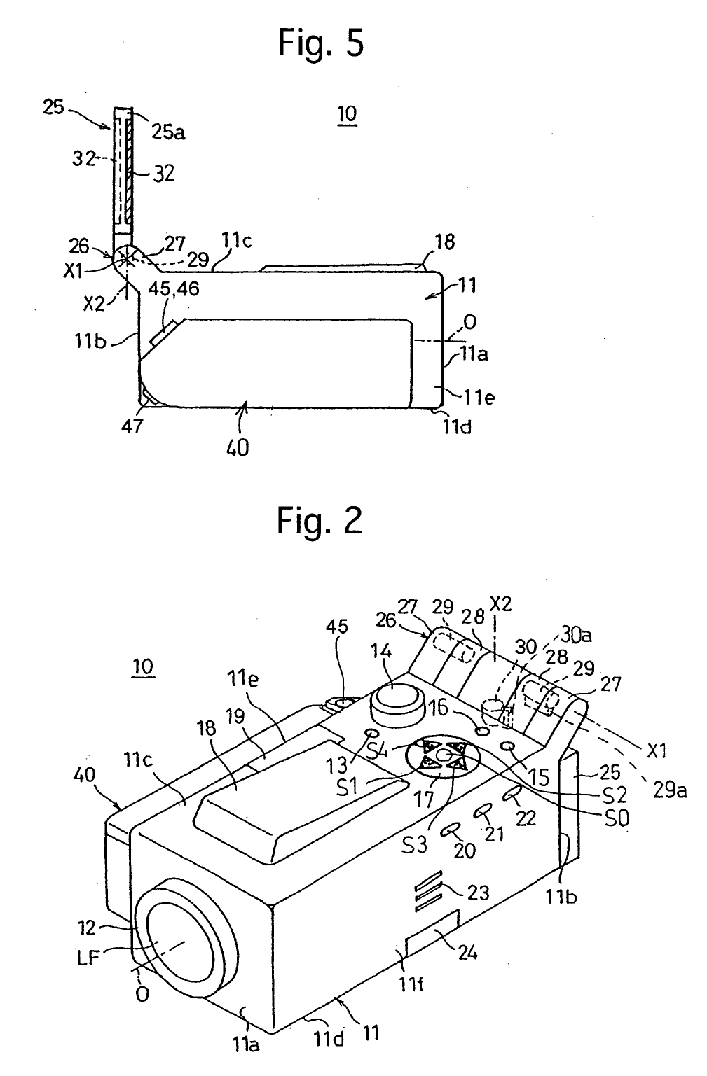

The digital camera 10 is provided, on the top surface 11c of the camera body 11 in an area thereon close to the rear end surface 11b, with a mode select dial 14 and various manual operational buttons such as a power button 13, a playback button 15, a menu button 16 and a five-way control button (manual operating switches/multi-direction control button/manual operation member) 17. The power button 13 serves as a manual operational member for turning ON and OFF a main switch of the digital camera 10. The mode select dial 14 serves as a manual operational member for selecting a desired photographing mode from among different photographing modes. The playback button 15 serves as a manual operational member for reproducing stored images on a liquid crystal display (LCD) portion (display panel) 32. The five-way control button 17 is constructed from a momentary switch which can be operated to move in different directions. The five-way control button 17 can be operated in biaxial directions orthogonal to each other (four directions: forward, rearward, right and left), and also in a press-down direction at an intersection of the aforementioned biaxial directions, i.e., at the center thereof. More specifically, the five-way control button 17 is provided with four-way operating portions: an up push-button portion (manual operating switch) S1, a down push-button portion (manual operating switch) S2, a left push-button portion (manual operating switch) S3, and a right push-button portion (manual operating switch) S4. The five-way control button 17 is also provided with a press-down-direction operating portion S0 (see FIGS. 1 and 2). Immediately after the menu button 16 is operated, control enters a setup mode in which various settings on the digital camera 10 can be changed and selected by operating the up push-button portion S1 and the down push-button portion S2 or the left push-button portion S3 and the right push-button portion S4 of the five-way control button 17. The various settings in the setup mode include image size, quality, white balance, sensitivity (ISO) and others, but are not limited solely to these particular settings. The five-way control button 17 is also used to change playback images indicated on the LCD portion 32.

The digital camera 10 is provided, on top of the camera body 11 in front of the aforementioned various manual operational buttons including the power button 13, the playback button 15, the menu button 16 and the five-way control button 17, with a pop-up flash 18. The pop-up flash 18 can be switched between a pop-up position in which a light emitting portion of the pop-up flash 18 projects upwards from the top surface 11c of the camera body 11, and a retracted position in which the light emitting portion of the pop-up flash 18 is retracted into the top surface 11c of the camera body 11. In each of FIGS. 1 through 5, the pop-up flash 18 is in the retracted position, and accordingly, the light emitting portion of the pop-up flash 18 is not shown. The camera body 11 is provided in the vicinity of the ridge (border) between the upper surface 11c and the right side surface 11e with a card slot lid 19 for covering a card slot (not shown) formed on the camera body 11. This card slot is accessible from the outside of the camera body 11 by opening the card slot lid 19. In a state in which the card slot lid 19 is open, a removable memory card 61 (FIG. 1), in which image data can be stored, can be inserted and removed into and from the memory card slot.

The digital camera 10 is provided, on the left side surface 11f of the camera body 11 at regular intervals in the optical axis direction, with a flash mode select button 20, a drive mode select button 21 and a focus mode select button 22. The flash mode select button 20, the drive mode select button 21 and the focus mode select button 22 are positioned in substantially the same range, in the optical axis direction, as the aforementioned various manual operational members (13 through 17) in the optical axis direction. The flash mode select button 20 serves as a manual operational member for controlling the operation of the light emitting portion of the pop-up flash 18. By operating the flash mode select button 20, a desired flash mode can be selected from among different flash modes such as auto flash mode, compulsory flash mode, suppressed flash mode and red-eye reduction mode. The drive mode select button 21 serves as a manual operational button for selecting a drive mode at a shutter release from among different drive modes such as normal drive mode (single-frame mode), multi-frame consecutive photographing mode, self-timer photographing mode and auto-bracketing photographing mode. The focus mode select button 22 serves as a manual operational member for selecting a focus mode from among different focus modes such as normal auto focus mode, macro (close-up) photographing mode, infinity photographing mode and manual focus mode. The digital camera 10 is provided, on the left side surface 11f of the camera body 11 slightly in front of the flash select button 20, with speaker slits 23, and is further provided, on the camera body 11 below the speaker slits 23, with an external connector cover 24. The external connector cover 24 can be opened and closed (or detached and attached) with respect to the left side surface 11f of the camera body 11. The digital camera 10 is provided, in an internal space of the camera body 11 immediately behind the external connector cover 24, with a jack substrate (not shown) to which an AV (audiovisual) jack for connection to an AV device such as an external display monitor and an adapter jack for power adapter (e.g., AC adapter) are mounted. The AV jack and the adapter jack are exposed on the left side surface 11f to be accessible from the outside of the camera body 11 if the external connector cover 24 is opened.

The digital camera 10 is provided at the back of the camera body 11 (on the rear end surface 11b) with an LCD monitor unit (display device) 25 which is mounted to the camera body 11 via a hinge portion 26 formed along the ridge (border) between the rear end surface 11b and the top surface 11c. The hinge portion 26 includes a pair of support arms 27, a middle support arm 28 and a pair of pivot pins 29. The pair of support arms 27 project from the camera body 11 at positions thereon laterally apart from each other. The middle support arm 28 to which the LCD monitor unit 25 is fixed to be supported thereby is held between the pair of support arms 27. The pair of pivot pins 29 project in opposite lateral directions away from each other from opposite ends of the middle support arm 28 to be respectively inserted into pin holes of the pair of support arms 27. Due to this structure of the hinge portion 26, the pair of support arms 27 and the middle support arm 28 can rotate relative to each other about the pair of pivot pins 29. An axis X1 (axis of rotation of the LCD monitor unit 25) of the pair of pivot pins 29 extends in a lateral direction of the digital camera 10 that is orthogonal to the optical axis O. The LCD monitor unit 25 can be manually rotated about the axis X1 between a retracted position (seated position; the position shown in FIG. 4) in which the LCD monitor unit 25 is positioned on the rear end surface 11b to sit on the optical axis O, and an upright position (the position shown in FIG. 5) in which an edge of the LCD monitor unit 25, which is on the opposite side of the LCD monitor unit 25 from the middle support arm 28, is positioned above the hinge portion 26. When in the retracted position, the LCD monitor unit 25 lies in a plane substantially orthogonal to the optical axis O.

A rectangular frame portion 25a of the LCD monitor unit 25 is provided with four edge portions surrounding the rectangular LCD portion (display panel) 32. The shape and size of the LCD monitor unit 25 are determined so that three of the four edge portions of the frame portion 25a, except for one of the four edge portions which is adjacent to the middle support portion 28, are substantially flush with the bottom surface 11d, the right side surface 11e and the left side surface 11f, respectively, when the LCD monitor unit 25 is in the retracted position, in which the LCD monitor unit 25 is positioned on the rear end surface 11b of the camera body 11 as shown in FIG. 4 (see FIG. 3).

FIG. 4 shows a state in which the LCD monitor unit 25 is in the retracted position with the LCD portion 32 (shown as the diagonally shaded area in FIG. 4) facing toward the rear of the digital camera 10 (leftward as viewed in FIG. 4). In this state shown in FIG. 4, if the LCD monitor unit 25 is rotated about the axis X1 to stand vertically as shown in FIG. 5, the LCD portion 32 faces toward the front of the digital camera 10 (rightward as viewed in FIG. 5). This state shown in FIG. 5, in which the LCD portion 32 faces forward, is suitable for the case where the user photographs himself/herself (self portrait) while holding the digital camera 10. Although FIG. 5 only shows a state of the LCD monitor unit 25 which is rotated about the axis X1 by approximately 180 degrees from the retracted state thereof (of FIG. 4) to stand vertically, the hinge portion 26 is provided with a frictional mechanism (or a click mechanism) by which the LCD monitor unit 25 can be stopped at other angular positions between the retracted position and the upright position.

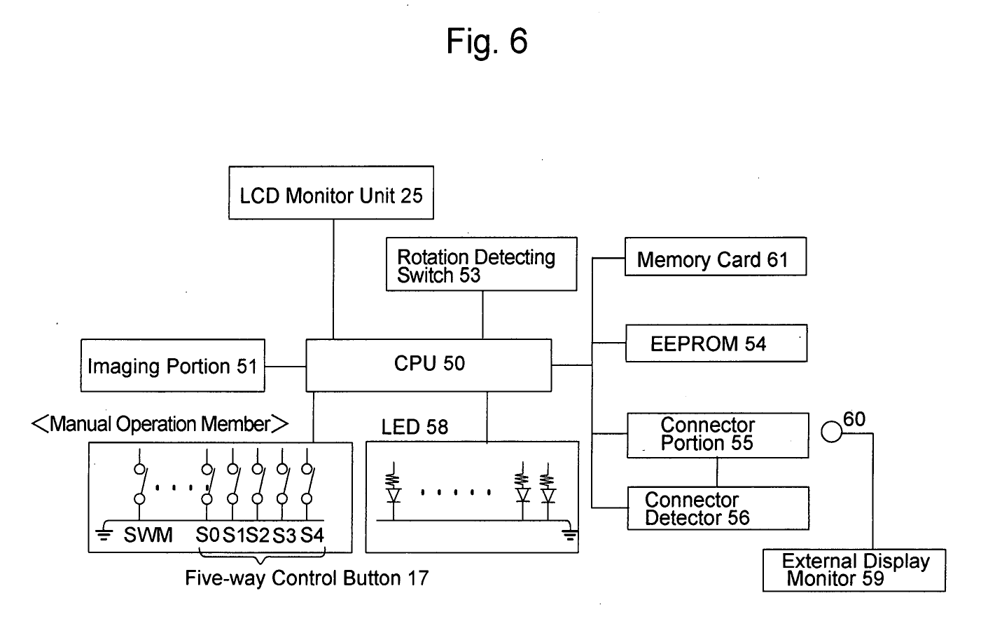

Although the right and left sides of the LCD portion 32 are inverted and the top and bottom sides of the LCD portion 32 are inverted between the retracted position shown in FIG. 4 and the upright position shown in FIG. 5, the digital camera 10 is provided with a detector 29a (see FIGS. 1 through 3) for detecting a change in rotational position of the LCD monitor unit 25 about the axis X1, and an image controller (which includes a CPU 50 shown in FIG. 6) for indicating a captured image on the LCD portion 32 in a correct position as viewed from the user in accordance with the result of detection of the detector 29a. The detector 29a is provided with a radial pin which projects from one of the pair of pins 29 in a radial direction thereof and a micro switch (not shown) positioned so as to be associated with the radial projection and capable of detecting whether the LCD monitor unit 25 is in either the retracted position shown in FIG. 4 or the upright position shown in FIG. 5.

The digital camera 10 is provided on the right side surface 11e with a grip 40. The grip 40 is formed in a substantially rectangular parallelepiped similar to the camera body 11. The grip 40 is pivoted (rotatable) on the camera body 11 about a pivot shaft (not shown) which projects from the camera body 11 in a direction substantially parallel to the axis X1. The grip 40 is provided thereon with a release button 45, a ring-shaped zoom switch 46 which surrounds the release button 45, and a moving-image recording button 47. The release button 45 serves as a manual operational member for photographing still images. A photometering operation and a distance measuring operation are carried out when the release button 45 is depressed halfway down, and a shutter is released when the release button 45 is fully depressed. Prior to these operations, a photographing mode and other settings are set with the above described various manual-operational members as appropriate. On the other hand, the moving-image recording button 47 serves as a manual operational member for recording moving images. An operation of recording moving images commences immediately after the moving-image recording button 47 is depressed once, and thereafter stops immediately after the moving-image recording button 47 is depressed once again. The still images and moving images are processed via an image processor to be stored in the memory card 61 as electronic image data. In addition to the memory card 61, the digital camera 10 can be provided therein with a built-in memory (non-removable memory) in which the processed still images and moving images can be stored.

A control system provided in the present embodiment of the digital camera 10 will be hereinafter discussed with reference to FIG. 6. Although only major elements of the control system of the digital camera 10 are shown as block diagrams in FIG. 6, the digital camera 10 is provided with other elements that are generally provided in conventional digital cameras for image recording and playback capabilities though such elements are not shown. The control system of the digital camera 10 is provided with an imaging portion 51 which firstly converts an object image formed on an image pickup device (e.g., a CCD or CMOS image sensor; not shown) through the photographing optical system into an electrical signal, and subsequently performs an image processing on the obtained electrical signal to output this signal as image data. Thereafter, this image data obtained through the imaging portion 51 is indicated as a visual image on the LCD monitor unit 25 and/or stored in the memory card 61. The image data stored in the memory card 61 is visually indicated on the LCD monitor unit 25 or an external display monitor 59 by operating the playback button 15 when playback mode is selected.

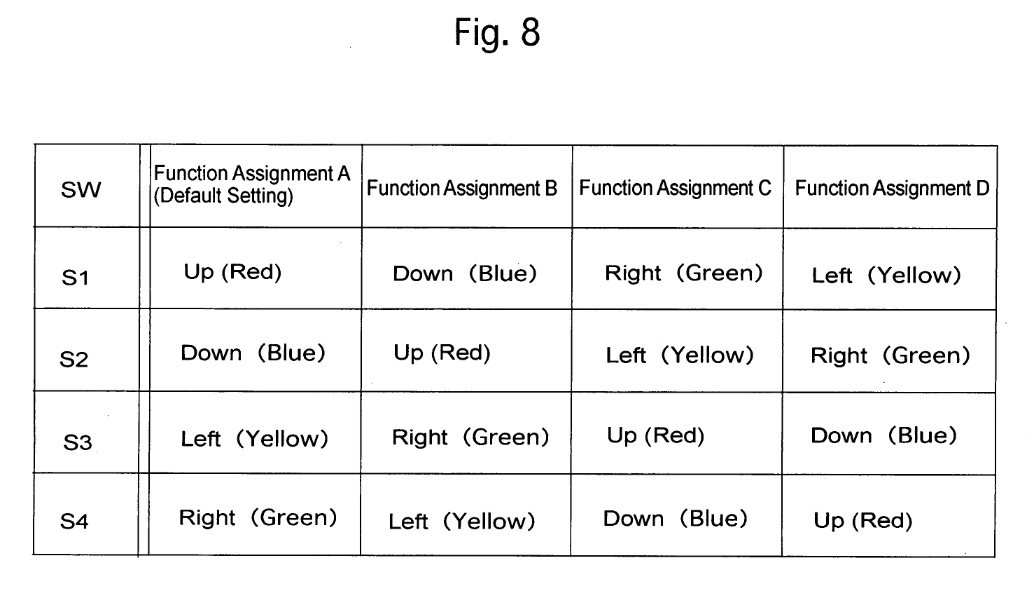

The control system of the digital camera 10 is provided with a rotation detecting switch 53 which is composed of the detector 29a that includes the radial projection and the micro switch mentioned above. The rotation detecting switch 53 outputs a detection signal to the CPU 50. The CPU 50 and the rotation detecting switch 53 constitute an orientation detecting device. The CPU 50 inverts the image indicated on the LCD monitor unit 25 right-left and top-bottom as appropriate, in accordance with the detection signal output from the rotation detecting switch 53, and simultaneously, assigns different capabilities to the four-way operating portions (switches) S1, S2, S3 and S4 of the five-way control button 17. The control system of the digital camera 10 is provided with a plurality of LEDs (light emitter/function informing device) 58 which illuminate the four-way operating portions S1, S2, S3 and S4 from undersides thereof in predetermined different colors or in different indicating manners in accordance with the different functions assigned to the four-way operating portions S1, S2, S3 and S4 of the five-way control button 17, respectively, to inform the user which of the different functions is assigned to which of the four-way operating portions S1, S2, S3 and S4. FIG. 8 shows an example of such a visual indicating manner using the LED's 58 which illuminate the four-way operating portions S1, S2, S3 and S4 in predetermined different colors: red, green, blue and yellow. Specifically, the four-way operating portions S1, S2, S3 and S4 are illuminated red, blue, yellow and green if assigned as an up button (UP), down button (DOWN), left button (LEFT), and right button (RIGHT), respectively. To apply such an indicating manner using different colors of illumination, each of the four-way operating portions S1 through S4 of the five-way control button 17 is made of a translucent material, and the LEDs 58 (RGB LEDs) are provided in each of the four-way operating portions S1 through S4. The control system of the digital camera 10 is provided with an EEPROM 54 in which data on the assignments of functions to the four-way operating portions S1, S2, S3 and S4 are stored in advance. The CPU 50 reads out the data on the assignments of functions to the four-way operating portions S1, S2, S3 and S4 as appropriate in accordance with the detection signal output from the rotation detecting switch 53. As shown in FIG. 8, when initializing the settings upon the power being switched ON, function assignment A (the four-way operating portions S1, S2, S3 and S4 are assigned as up button (UP), down button (DOWN), left button (LEFT) and right button (RIGHT), respectively) is selected. Function assignment B (the four-way operating portions S1, S2, S3 and S4 are assigned as down button (DOWN), up button (UP), right button (RIGHT) and left button (LEFT), respectively) is selected when the rotation detecting switch 53 detects that the LCD monitor unit 25 is in the upright position as shown in FIG. 5. Although the functions assigned to the four-way operating portions S1, S2, S3 and S4 change according to the circumstances of the digital camera 10, in the most cases the up button is assigned as an increment button or a select button, the down button is assigned as a decrement button or a cancel button, the right button is assigned as an increment button or a forward-scroll button, and the left button is assigned as a decrement button or a reverse-scroll button.

The control system of the digital camera 10 is provided with a connector portion 55 which is composed of the aforementioned AV jack to which a connector 60 for connecting to the external display monitor 59 is connected. The control system of the digital camera 10 is provided with a connector detector 56 for detecting whether the connector 60 is connected to the AV jack. Upon detecting that the connector 60 is connected to the AV jack via the connector detector 56, the CPU 50 reads out the image data from the memory card 61 and converts the image data into an image signal having a predetermined format to output this signal. If the connector detector 56 detects that the connector 60 is connected to the AV jack, the connector detector 56 enables the CPU 50 to output the image signal, and prohibits the assignments of the functions, to the four-way operating portions S1, S2, S3 and S4 of the five-way control button 17 from being changed to maintain the assignments of the functions at the time of connection of the connector 60 to the AV jack.

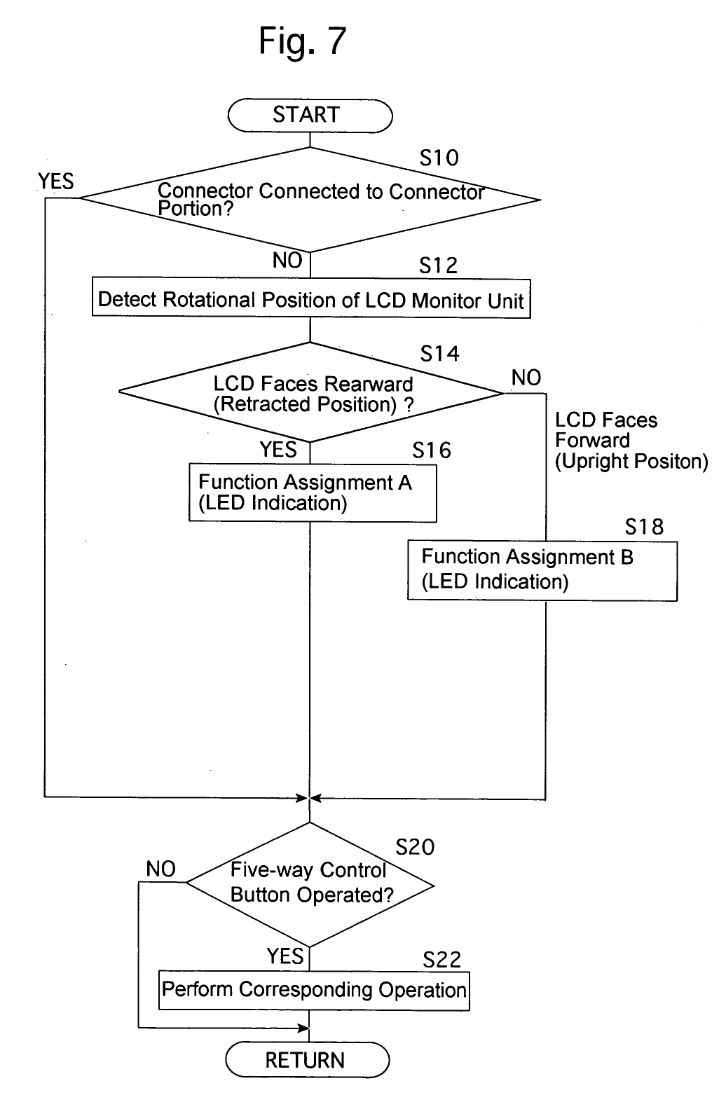

FIG. 7 is a control flow chart showing a process of setting functions on the five-way control button 17. This process commences to be performed by the CPU 50 at predetermined intervals immediately after the main power of the digital camera 10 is turned ON. The controls by the CPU 50 are carried out in accordance with programs written in an internal ROM of the CPU 50. In this process, firstly it is determined at step S10 whether the connector 60 is currently connected to the connector portion 55 (AV jack). If it is determined that the connector 60 is currently connected to the connector portion 55 (if YES at step S10), control proceeds to step S20 at which it is determined whether the five-way control button 17 is currently operated. If it is determined that the connector 60 is not connected to the connector portion 55 (if NO at step S10), control proceeds to step S12 at which the CPU 50 detects the rotational position (the upright position or the retracted position) of the LCD monitor unit 25 via the rotation detecting switch 53 (the detector 29a). With the result of this detection at step S12, it is determined at step S14 whether the LCD monitor unit 25 faces toward the rear of the digital camera 10 as shown in FIG. 4. If it is determined at step S14 that the LCD monitor unit 25 is in the retracted position as shown in FIG. 4 (if YES at step S14), control proceeds to step S16 at which the CPU 50 reads out data on the function assignment A from the EEPROM 54 to assign the function assignment A as a default assignment for the five-way control button 17. If it is determined at step S14 that the LCD monitor unit 25 is not in the retracted position (if NO at step S14), it is considered that the LCD monitor unit 25 is in the upright position as shown in FIG. 5, and accordingly, control proceeds to step S18 at which the CPU. 50 reads out data on the function assignment B from the EEPROM 54 to assign the function assignment B to the five-way control button 17. After the completion of the operation at step S16 or S18, at which the four-way operating portions S1, S2, S3 and S4 are respectively assigned as up button (UP), down button (DOWN), left button (LEFT), and right button (RIGHT), or are respectively assigned as down button (DOWN), up button (UP), right button (RIGHT), and left button (LEFT), operations corresponding to the functions assigned to the four-way operating portions S1, S2, S3 and S4 of the five-way control button 17 are performed at step S22 if it is determined at step S20 that the four-way operating portions S1, S2, S3 and S4 of the five-way control button 17 are currently operated. Control skips the operation at step S22 if it is determined at step S20 that the five-way control button 17 is not currently operated, and control returns.

The functions assigned to the five-way control button 17 have been described above. More specifically, in a photographing mode (image recording mode), the left push-button portion S3 and the right push-button portion S4 serve as an EV (exposure value) shift-up (+) button and an EV shift-down (−) button, respectively. In a playback mode, the up push-button portion S1 and the down push-button portion S2 serve as a scroll-up button and a scroll-down button for scrolling up and down a portion of a zoom-in image which is indicated on the LCD monitor unit 25, respectively, while the left push-button portion S3 and the right push-button portion S4 serve as a frame-forward button and a frame-reverse button, respectively. During the time a menu appears on the LCD monitor unit 25, one or more functions of the digital camera 10 such as an autofocusing capability are selected from among various functions of the digital camera 10 by operating the five-way control button 17.

In the present embodiment of the digital camera 10, during playback of recorded still and/or moving images on the LCD portion 32, it is assumed that the user holds the digital camera 10 with the fingers placed on the upper surface 11c of the camera body 11. Accordingly, manual operational members used for playback images such as the playback button 15 and the five-way control button 17 are positioned on the top surface 11c, so that the user can easily operate these manual operational members without changing the above described photographing posture. During playback of recorded still and/or moving images, the user can hold the digital camera 10 with both hands holding the camera body 11 with the grip 40 positioned in the retracted position.

Although the rotational direction of the LCD monitor unit 25 has been directed only to the rotational direction thereof about the axis X1 in the above description, the LCD monitor unit 25 can also be rotated on another axis of rotation orthogonal to the optical axis O when the LCD monitor unit 25 is in the upright position. In the present embodiment of the digital camera 10, the LCD monitor unit 25 is supported by the middle support arm 28 to be rotatable on the axis X2 (axis of rotation) that is orthogonal to the axis X1. More specifically, a rotational pin 30 projects from a rectangular frame portion 25a of the LCD monitor unit 25 along the axis X2 thereon, while a pin-insertion hole in which the rotational pin 30 is rotatably fitted is formed on the middle support arm 28. Accordingly, the LCD monitor unit 25 is rotatable both about the axis X1 and on the axis X2. The LCD portion 32 can be orientated to the left side or the right side of the digital camera 10 by rotating the LCD monitor unit 25 in the upright position on the axis X2 as shown in FIG. 9. Additionally, from this upright position, the LCD monitor unit 25 can be rotated about the axis X1 toward the retracted position after being flipped on the axis X2. Thereupon, the LCD portion 32 faces the rear end surface 11b as shown by dotted lines in FIG. 4 or faces rearwards as shown by dotted lines in FIG. 5. The retracted position shown in FIG. 4 with the LCD portion 32 facing the rear end surface 11b is desirable when the digital camera 10 is carried because the LCD portion 32 faces the rear end surface 11b to be prevented from being damaged.

As shown in FIGS. 1 through 3, the digital camera 10 is provided beside the rotational pin 30 with a detector 30a which is similar in structure to the above described detector 29a. Variations in rotational position of the LCD monitor unit 25 about the axis X2 can be detected by the detector 30a. In addition to the above described function assignments A and B for the four-way operating portions S1, S2, S3 and S4 of the five-way control button 17, data on function assignment C (the four-way operating portions S1, S2, S3 and S4 are assigned as right button (RIGHT), left button (LEFT), up button (UP) and down button (DOWN), respectively) and data on function assignment D (the four-way operating portions S1, S2, S3 and S4 are assigned as left button (LEFT), right button (RIGHT), down button (DOWN) and up button (UP), respectively) are stored in the EEPROM 54 in advance. The function assignment C is selected when the detector 30a detects that the LCD monitor unit 25 in the upright position is rotated on the axis X2 so that the LCD portion 32 faces rightward, while the function assignment D is selected when the detector 30a detects that the LCD monitor unit 25 in the upright position is rotated on the axis X2 so that the LCD portion 32 faces leftward.

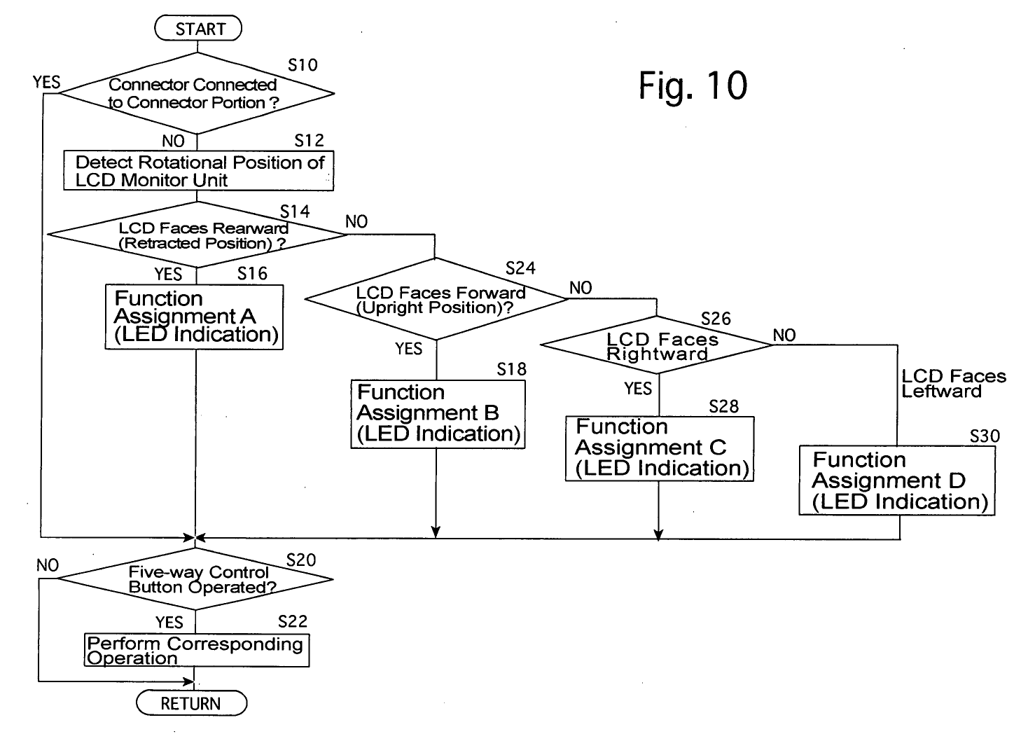

FIG. 10 is a control flow chart showing a process of setting functions on the five-way control button 17 in the case where the LCD monitor unit 25 is rotatable both about the axis X1 and on the axis X2. The control flow chart shown in FIG. 10, which is hereinafter discussed, includes several operations (operations at steps S24 through S30) which are added to the operations performed in the control flow chart shown in FIG. 7. If it is determined at step S14 that the LCD monitor unit 25 is not in the retracted position (if NO at step S14), it is determined at step S24 whether the LCD monitor unit 25 is in the upright position. If it is determined at step S24 that the LCD monitor unit 25 is in the upright position (if YES at step S24), control proceeds to step S18. If it is determined at step S24 that the LCD monitor unit 25 is not in the upright position (if NO at step S24), it is determined at step S26 whether the LCD monitor unit 25 is rotated on the axis X2 (the axis of the rotational pin 30) so that the LCD portion 32 faces rightward. If it is determined at step S26 that the LCD portion 32 faces rightward (if YES at step S26), control proceeds to step S28 at which the CPU 50 reads out data on the function assignment C from the EEPROM 54 to assign the function assignment C to the five-way control button 17. If it is determined at step S26 that the LCD portion 32 does not face rightward (if NO at step S26), it is considered that the LCD portion 32 faces leftward, and accordingly, control proceeds to step S30 at which the CPU 50 reads out data on the function assignment D from the EEPROM 54 to assign the function assignment D to the five-way control button 17. After completion of the operation at each of steps S28 and S30, control proceeds to step S20. If it is determined at step S20 that the five-way control button 17 is currently operated at step S20 (if YES at step S20), control proceeds to step S22 at which operations corresponding the functions assigned to the four-way operating portions S1, S2, S3 and S4 of the five-way control button 17 are performed. Control skips the operation at step S22 if it is determined at step S20 that the five-way control button 17 is not currently operated, and control returns.

Due to the above described structure and controls, an intended operation can be selectively performed by operating a plurality of manual operation members (operating portions/the five-way control button 17) in the same manner at any time regardless of the orientation of the LCD monitor unit 25. Consequently, the camera is easier to use and has an improved operability.

Moreover, the user does not confused about which of the different functions is assigned to which of the plurality of operating portions (S1, S2, S3 and S4) even if the assignments of the functions to the plurality of operating portions are changed because the user is informed of the change in the assignments of the functions by an informing device such as LEDs.

Although the present invention has been applied to the digital camera 10 in the above discussion, the present invention can be applied to other portable devices other than digital cameras, e.g., a mobile phone having a rotatable LCD panel.

Obvious changes may be made in the specific embodiments of the present invention described herein, such modifications being within the spirit and scope of the invention claimed. It is indicated that all matter contained herein is illustrative and does not limit the scope of the present invention.

1. A digital camera comprising:
a display device that is rotatably supported on a camera body of said digital camera, said display device indicating a plurality of selectable functions of the camera on a display panel;
an orientation detecting device which detects an angular position of said display device with respect to said camera body to determine an orientation of said display panel of said display device;
a plurality of manual operating switches, each of said manual operating switches being adapted to select said selectable functions indicated on said display panel; and
a controller for assigning functions to said manual operating switches,
wherein said controller changes assignments of said functions to said manual operating switches in accordance with said angular position of said display device detected by said orientation detecting device.

2. The digital camera according to claim 1, wherein said manual operating switches are positioned on a top surface of said camera body.

3. The digital camera according to claim 1, wherein said display panel of said display device can be positioned to lie in a plane substantially orthogonal to an optical axis of a photographing optical system of said digital camera so that said display panel can be viewed at least from one of a front side and a rear side of said camera body by rotating said display device.

4. The digital camera according to claim 3, wherein said display device is rotatable on an axis which is orthogonal to said optical axis.

5. The digital camera according to claim 1, further comprising a function informing device for informing said functions assigned to said manual operating switches.

6. The digital camera according to claim 5, wherein said function informing device comprises at least one light emitter capable of emitting different colors of light for lighting said manual operating switches, and
wherein said controller controls operation of said light emitter so that said light emitter changes color of light emitted therefrom to change a color of each said manual operating switches in accordance with said result of detection of said orientation detecting device.

7. The digital camera according to claim 5, wherein said function informing device comprises a plurality of LEDs which are positioned inside said manual operating switches, respectively.

8. The digital camera according to claim 1, further comprising:
a connector portion to which an external device having a display monitor is connectable; and
a connector detector for detecting whether said external device is connected to said connector portion,
wherein said controller prohibits said assignments of said functions to said manual operating switches from being changed in the case where said connector detector detects that said external device is connected to said connector portion.

9. The digital camera according to claim 1, wherein said display device is pivoted to a rear end of said camera body.

10. The digital camera according to claim 4, wherein said display device is rotatable about a second axis which is orthogonal to said axis.

11. The digital camera according to claim 1, wherein said manual operating switches comprise a multi-direction control button which can be operated in biaxial directions orthogonal to each other.

12. A digital camera comprising:
a display device that is rotatably supported on a camera body of said digital camera, said display device indicating a plurality of selectable functions of the camera on a display panel;
a plurality of manual operating switches, each of said manual operating switches being adapted to select said selectable functions indicated on said display panel; and
a controller which changes assignments of functions to said manual operating switches in accordance with variations in an angular position of said display device relative to said camera body.

13. A portable device comprising:
a display device configured so that an orientation of a display panel of said display device relative to an operating portion is changeable;
an orientation detecting device for detecting a change in said orientation of said display panel;
a manual operation member, provided on said operating portion, for controlling an image display indicated on said display panel of said display device; and
a controller for controlling functions of said manual operation member,
wherein said controller changes functions of said manual operation member in accordance with said orientation of said display panel upon detecting a change in said orientation of said display panel from a result of detection of said orientation detecting device.
